(19) United States
(12) Patent Application Publication
(10) Pub. No.: US 2004/0267925 A1
(43) Pub. Date: Dec. 30, 2004

(54) System and method for IP logging

(76) Inventors: XingYu Zhou, Shenzhen (CN); Tang He, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/838,963

(22) Filed: May 4, 2004

(30) Foreign Application Priority Data
Jun. 25, 2003 (TW) 92117203

(51) Int. Cl. G06F 15/173

(52) U.S. Cl. 709/223

(57) ABSTRACT

An IP logging system includes a logging module (110), a netfilter (120), a klogd (kernel log daemon) processor (130), an event log (140), a logging API (Application Programming Interface) (150), a configuration manager (160) and a user interface (170). The netfilter is provided for obtaining message packets including required information from external networks. The logging module retrieves the required information from the message packets, and transmits the information to the klogd processor. Then the klogd processor transmits the information to the event log for recording. The logging API is used for switching the logging module on or off based on demands input from the user interface by users. The configuration manager is provided for managing software and hardware of the IP logging system of the present invention. An IP logging method is also disclosed.

### BACKGROUND OF THE INVENTION 1. Field of the Invention

The present invention relates to a computer-enabled log recording system and method, and particularly to a system and method for IP (Internet protocol) logging. 2. Background of the Invention

For computer systems connected to various communication networks, a firewall is an important defense. The firewall allows valid network traffic into and out from the computer system, while denying passage to invalid network traffic. This is based on a set of rules predetermined by webmasters or system managers. The rules inform the firewall which network traffic is valid. The rules also instruct the firewall on what to do with network traffic coming from a predetermined source, network traffic being directed to a predetermined destination, and network traffic having a specific protocol type.

Network traffic is made up of IP message packets (for simplicity, hereinafter simply called “message packets”). A message packet is a block of data transmitted from a source system to a destination system in flow form. Each message packet has a packet head that comprises data on the source, the destination and the protocol type of the message packet. The firewall checks the packet heads of the message packets based on the predetermined rules to determine which message packets will be accepted and which will be denied. This checking process is called filtering of message packets.

Conventional firewalls are only used for accepting and/or blocking message packets. Firewalls are seldom used to log IP information. There are no effective mechanisms for firewalls to be applied to acceptance of network information, so that users can obtain needed information by retrieving as little network traffic as possible.

### SUMMARY OF THE INVENTION

Accordingly, an object of the present invention is to provide an IP logging system for obtaining needed information from networks and for blocking unneeded information, which can combine the functions of firewalls and IP logging to reduce network traffic.

Another object of the present invention is to provide an IP logging method for obtaining needed information from networks and for blocking unneeded information.

In order to accomplish the first above-mentioned object, a preferred IP logging system comprises a logging module, a netfilter, a klogd (kernel log daemon) processor, an event log, a logging API (Application Programming Interface), a configuration manager and a user interface. The netfilter is provided for obtaining message packets comprising required information from external networks. The logging module retrieves the required information from the message packets, and transmits the information to the klogd processor. Then the klogd processor transmits the information to the event log for recording. The logging API is used for switching the logging module on or off based on demands input from the user interface by users. The configuration manager is provided for managing software and hardware of the IP logging system of the present invention.

In order to accomplish the second above-mentioned object, a preferred IP logging method comprises the following steps: (i) obtaining a message packet from networks; (ii) determining whether the message packet accords with one or more of predetermined match terms; (iii) retrieving information from the message packet if the message packet accords with one or more of the match terms; and (iv) transmitting the retrieved information to the event log for recording; or (v) blocking the message packet if the message packet does not accord with any one of the match terms.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of an IP logging system in accordance with the preferred embodiment of the present invention; and

FIG. 2 is a flow chart of a preferred IP logging method in accordance with the present invention.

### DETAILED DESCRIPTION OF PREFERRED EMBODIMENTS OF THE INVENTION

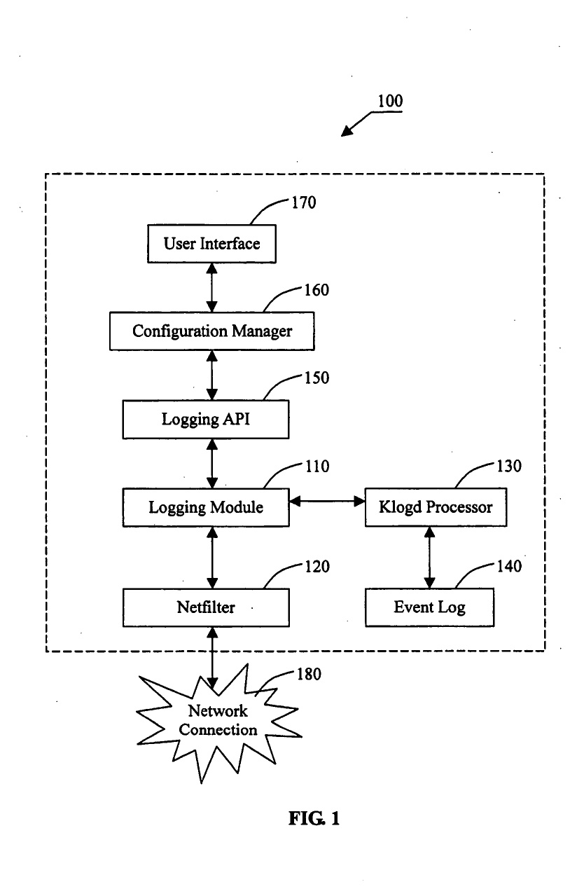

FIG. 1 is a schematic diagram of an IP logging system 100 in accordance with the preferred embodiment of the present invention. The IP logging system 100 comprises a logging module 110, a netfilter 120, a klogd (kernel log daemon) processor 130, an event log 140, a logging API (Application Programming Interface) 150, a configuration manager 160, and a user interface 170. The netfilter 120 is connected to a network connection 180.

The logging module 110 is provided for analyzing and processing message packets obtained by the netfilter 120, retrieving required information from the message packets, and transmitting the retrieved information to the event log 140 via the klogd processor 130. The logging module 110 can be a user space program or a kernel module. If the logging module 110 is a user space program, the program is relatively easy to debug. However, every message packet must be delivered to user space process through a memcpy and then sent back to kernel after being processed. Memcpy is a kind of function, which can copy any type of data with a predetermined data length. If the logging module 110 is a kernel module, the module simply needs to analyze the message packet structure in kernel. In the preferred embodiment of the present invention, the logging module 110 is a kernel module.

Because the logging module 110 is a kernel module, in the preferred embodiment of the present invention, a getsockopt and a setsockopt are employed respectively to get and set the configuration of the logging module 110. The getsockopt and the setsockopt are two functions defined in Linux, respectively for getting and setting sock options.

The netfilter 120 is executed in IPv4, IPv6, DECnet and other protocol stacks. In order to support the netfilter 120, the protocol stacks select five reference points in the enumeration paths of message packets thereon. The five reference points are respectively named PREROUTING, LOCAL-IN, FORWARD, LOCAL-OUT and POSTROUTING. The netfilter 120 is a series of hooks in the five reference points, which is essentially a function that can process message packets hooked from the five reference points. The hooks are defined in Linux as following:

struct nf_hook_ops
{

struct list_head list;
nf_hookfn *hook;
int pf;
int hooknum;
int priority;

};

The kernel of the netfilter 120 provides a structure for analyzing and processing message packets; however the kernel does not analyze and process the message packets in detail. Detailed analysis and processing of the message packets are performed by the logging module 110. The kernel can distribute the message packets to corresponding modules, which can process the message packets based on rules in a table. The table is a collection of rules that are similar to firewalls. The rules can determine whether network traffic is valid. The rules can also determine what to do with network traffic coming from a predetermined source, network traffic bound for a particular destination, and network traffic having a specific protocol type. When being started, each of the modules would register to the kernel. Via the register, the kernel can know which modules have target functions, and which modules have match functions.

A target function is an operation performed on those message packets that comply with the rules. A user can define all kinds of target functions. The following are some commonly-used target functions.

ACCEPT: when a message packet complies with the ACCEPT target function, the message packet is accepted, and is allowed to go to the destination thereof.

DROP: when a message packet complies with the DROP target function, the message packet is blocked.

REJECT: when a message packet complies with the REJECT target function, the message packet is blocked. Blockage information regarding the message packet can be transmitted to a dispatcher of the message packet.

A match function defines match terms that a message packet should accord with. Match functions are divided into two types: general match and specific match. The following are some general matches.

-p or -protocol: the protocol match is used for matching message packets according to their protocol types. The protocol types comprise TCP (Transfer Control Protocol), UDP (User Datagram Protocol), ICMP (Internet Control Messages Protocol), any combination of the foregoing, and ALL (for all protocol types). ALL is a default match. Alternatively, a “!” can be added after the -p for indicating not matching the protocol match.

-s or -source: the source match is used for matching message packets according to their source IP addresses. The source match also allows matching with IP addresses in a certain range. Alternatively, a “!” can be added after the -s for indicating not matching the source match.

-d or -destination: the destination match is used for matching message packets according to their destination IP addresses. The destination match also allows matching with IP addresses in a certain range. Alternatively, a “!” can be added after the -d for indicating not matching the destination match.

Besides the above-mentioned matches, users can define other matches according to their needs via the user interface 170.

The klogd processor 130 is used for transmitting retrieved information sent by the logging module 110 to the event log 140. The event log 140 is provided for recording the information transmitted by the klogd processor 130. The logging API 150 is used for switching the logging module 110 on or off, and for showing a current logging status. The configuration manager 160 manages software and hardware of the IP logging system 100, and collects configuration information of the software and hardware. The user interface 170 is used by users to input demands to the IP logging system 100, such as switching the logging module 110 on or off. The user interface 170 may be a command line interface (CLI), or a web interface.

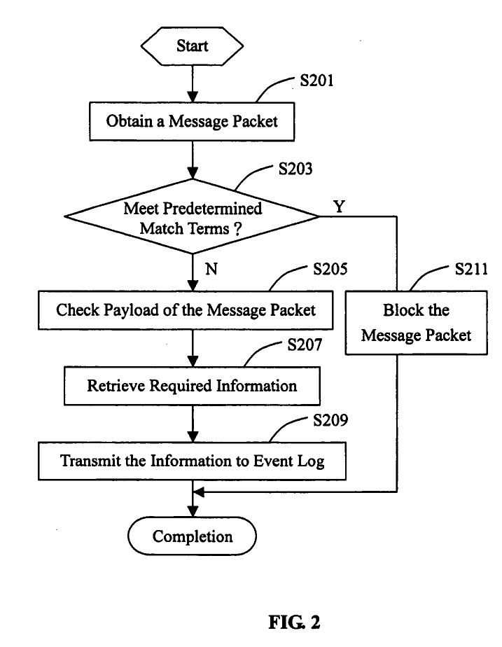

FIG. 2 is a flow chart of the preferred IP logging method in accordance with the present invention. At step S201, the netfilter 201 obtains a message packet from external networks via the network connection 180. At step S203, the netfilter 201 determines whether the obtained message packet accords with one or more match terms defined by the match functions. The match terms comprise the protocol match, the source match, and the destination match. If the message packet does not accord with any of the match terms, at step S211, the netfilter 120 blocks the message packet. In such case, the logging module 110 does not process the message packet, and therefore network traffic is reduced. If the message packet accords with one or more of the match terms, at step S205, the logging module 110 checks a content of the message packet. At step S207, the logging module 110 retrieves required information from the message packet, and formats the information in a predetermined format. At step S209, the logging module 110 transmits the formatted information to the event log 140 via the klogd processor 130.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. An IP logging system for obtaining information from one or more networks according to predetermined terms, the system comprising:
a netfilter for obtaining message packets from networks based on at least one predetermined term;
a logging module for analyzing and processing the obtained message packets to obtained required information; and
an event log for recording the obtained information.

2. The IP logging system as claimed in claim 1, further comprising a klogd processor for transmitting the information obtained by the logging module to the event log.

3. The IP logging system as claimed in claim 1, further comprising an application programming interface (API) for switching the logging module on or off, and for showing a current logging status.

4. The IP logging system as claimed in claim 1, further comprising a user interface for users to sending demands.

5. The IP logging system as claimed in claim 4, wherein the user interface is a command line interface (CLI).

6. The IP logging system as claimed in claim 4, wherein the user interface is a web interface.

7. The IP logging system as claimed in claim 1, further comprising a configuration manager for managing software and hardware of the IP logging system.

8. An IP (Internet protocol) logging method for obtaining information from one or more networks according to predetermined match terms, the method comprising the steps of:
obtaining a message packet from the networks;
determining whether the message packet accords with at least one of the predetermined match terms;
retrieving required information from the message packet if the message packet accords with at least one of the predetermined match terms; and
transmitting the retrieved information to an event log.

9. The IP logging method as claimed in claim 8, further comprising the step of:
blocking the message packet if the message packet does not accord with any one of the predetermined match terms.

10. The IP logging method as claimed in claim 8, wherein the predetermined terms comprise a source IP address.

11. The IP logging method as claimed in claim 8, wherein the predetermined terms comprise a destination IP address.

12. The IP logging method as claimed in claim 8, wherein the predetermined terms comprise a protocol type of the message packet.

13. The IP logging method as claimed in claim 8, further comprising the step of: checking content of the message packet.

14. The IP logging method as claimed in claim 8, further comprising the step of: formatting the retrieved information according to a predetermined format.

15. An IP (Internet protocol) logging method for obtaining information from one or more networks according to predetermined match terms, the method comprising the steps of:
(a) obtaining a message packet from the networks;
(b) determining whether the message packet accords with at least one of the predetermined match terms; and
(c) blocking the message packet if the answer of step (b) is yes.
